(19) United States
(12) Patent Application Publication
(10) Pub. No.: US 2009/0089257 A1
(43) Pub. Date: Apr. 2, 2009

(54) METHOD AND APPARATUS FOR PROVIDING CONTENT SUMMARY INFORMATION

(75) Inventors: Sang-wook Cho, Suwon-si (KR); Cheol-Ju Hwang, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics, Co., Ltd., Suwon-si (KR)

(21) Appl. No.: 12/117,826

(22) Filed: May 9, 2008

(30) Foreign Application Priority Data
Oct. 1, 2007 (KR) 2007-98903

(51) Int. Cl. G06F 17/30

(52) U.S. Cl. 707/3; 707/E17.001

(57) ABSTRACT

A method to provide content summary information by using a web content syndication format includes selecting keywords which satisfy a predetermined condition from among a plurality of keywords extracted from a plurality of pieces of content summary information, indicating at least one of the selected keywords through a user selection from among the selected keywords, and displaying a plurality of pieces of content summary information all of which are related to the indicated keyword.

### CROSS-REFERENCE TO RELATED APPLICATION

This application claims the benefit of Korean Application No. 2007-98903, filed Oct. 1, 2007 in the Korean Intellectual Property Office, the disclosure of which is incorporated herein by reference.

### BACKGROUND OF THE INVENTION

1. Field of the Invention

Aspects of the present invention relate to a method and apparatus to provide content summary information, and more particularly, to a method and apparatus to provide content summary information by using a content syndication format.

2. Description of the Related Art

Due to the recent rapid increase in web content, it is difficult for users to quickly and accurately retrieve desired content. In order to solve this problem, a content syndication format, such as Rich Site Summary (RSS) or Atom, has been provided. By using such a content syndication format, a website, in which content such as news is frequently updated, can easily provide users with information regarding the updated content. Therefore, once an address of the RSS is registered in a predetermined program, such as an RSS reader, users can automatically check and use updated information.

FIG. 1 is a diagram illustrating a screen 100 which displays content summary information 130, provided in the form of a conventional RSS. Referring to FIG. 1, the screen 100 displays a collection of categories 110, a plurality of pieces of the content summary information 130, and a provider 140.

A user terminal receives an RSS file from content summary information providers which have been previously registered. The RSS file transmitted from the content summary information providers is typically in the form of an Extensible Markup Language (XML). The user terminal parses the RSS file by using an XML parser, and thereby extracts the plurality of pieces of the content summary information 130. The extracted pieces of the content summary information 130 are categorized into predetermined categories. If a user selects a category, content summary information, which corresponds to the selected category 110 and is selected from among the plurality of pieces of the content summary information 130 received from the content summary information providers, is displayed.

In the example shown in FIG. 1, the user selected a news category 111. As a result, a plurality of pieces of the content summary information 130 related to news is displayed.

However, content summary information provided by different content summary information providers 140 may actually refer to the same content. For example, as shown in FIG. 1, one piece of the content summary information 130 titled “gas prices have fallen after 18 weeks . . . . Korean Won (‘KW’) 1553.09 per liter” 133 is provided by the content summary information provider E-daily 143. Meanwhile, another piece of the content summary information 130 titled “retail price of gas has fallen by KW 1 after 18 weeks . . . KW 1553” 135 is provided by a separate content summary information provider Yonhap News Agency 145. However, the aforementioned two pieces 133 and 135 of the content summary information 130 both correspond to the same content.

Also, content summary information provided by the same content summary information provider may be redundantly displayed. For example, pieces of the content summary information 137, 138 titled “three persons injured due to bombing accident during drill” are displayed twice, which are pieces of the content summary information 130 provided by the content summary information provider Pohang/Seungmok Baek 147 and 148. These two pieces of the content summary information 137 and 138 are redundantly displayed.

The reason for such a redundant display is that the user has registered an address of a blog “A” as the content summary information provider, and the content summary information 137, 138 titled “three persons injured due to bombing accident during drill” are linked as content summary information 130 in the blog “A.” That is, the user directly receives the content summary information 137 from the content summary information provider Pohang/Seungmok Baek 147, and simultaneously receives the same content summary information 138 from link information provided by the blog “A” which links to the content information provider Pohang/Seungmok Baek 148.

In this manner, when content summary information 130 regarding the same content is redundantly displayed, there is a decrease in the efficiency of the content syndication technology, which is used to obtain content desired by a user. In particular, if the number of content summary information providers 110 registered by a user increases, the number of pieces of the content summary information 130 transmitted to the user also likely increases. As a result, the number of cases in which the content summary information 130 is redundantly displayed greatly increases, thereby causing inconvenience for users.

### SUMMARY OF THE INVENTION

Aspects of the present invention provide a method and apparatus to efficiently provide content summary information.

According to an aspect of the present invention, a method of providing content summary information includes selecting keywords which satisfy a predetermined condition from among a plurality of keywords extracted from a plurality of pieces of content summary information, indicating at least one of the selected keywords through a user selection from among the selected keywords, and displaying a plurality of pieces of content summary information all of which are related to the indicated keyword.

According to an aspect of the present invention, the predetermined condition is in regard to a number of redundant extractions for the plurality of keywords extracted from the plurality of pieces of content summary information.

According to an aspect of the present invention, the predetermined condition is in regard to user desired content information that is previously set before the selecting of the keywords.

According to an aspect of the present invention, the operation of displaying the plurality of pieces of content summary information includes the operations of comparing each of the pieces of content summary information comprising the at least one indicated keyword, based on the keywords extracted from the plurality of pieces of content summary information related to the at least one indicated keyword, categorizing pieces of the content summary information including the at least one keyword which are redundant into a same group, based on a result of the comparing, and displaying only one piece of the content summary information from among the plurality of pieces of content summary information which are categorized into the same group.

According to an aspect of the present invention, the operation of categorizing includes the operation of categorizing the plurality of pieces of content summary information having a number of matched keywords over a predetermined number into the same group.

According to an aspect of the present invention, the operation of categorizing includes categorizing the plurality of pieces of content summary information in which a percentage of matched keywords is respectively over a threshold percentage value into the same group.

According to an aspect of the present invention, the plurality of pieces of content summary information is provided from a registered content summary information provider.

According to an aspect of the present invention, the content summary information is Rich Site Summary (RSS) data.

According to another aspect of the present invention, a content summary information providing apparatus includes a keyword selection unit to select keywords which satisfy a predetermined condition from among a plurality of keywords extracted from a plurality of pieces of content summary information, an indication unit to indicate at least one of the selected keywords according to a received user selection, and a display unit to display a plurality of pieces of content summary information each of which is related to the at least one indicated keyword.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other features and advantages of the invention will become apparent and more readily appreciated from the following description of the embodiments, taken in conjunction with the accompanying drawings of which:

FIG. 1 is a diagram illustrating a screen on which is displayed content summary information, provided in the form of a conventional Rich Site Summary (RSS) format;

FIG. 2 is a block diagram of a content summary information providing apparatus according to an embodiment of the present invention;

FIG. 3 is a block diagram of a content summary information providing apparatus according to another embodiment of the present invention;

FIG. 4 is a diagram illustrating a screen of the content summary information providing apparatus of FIG. 2, on which is displayed a plurality of pieces of content summary information;

FIG. 5A is a diagram illustrating a screen of the content summary information providing apparatus of FIG. 2, on which is displayed a plurality of pieces of content summary information;

FIG. 5B is a diagram illustrating a screen of the content summary information providing apparatus of FIG. 3, on which is displayed the plurality of pieces of content summary information; and

FIG. 6 is a flowchart of a method of providing content summary information according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

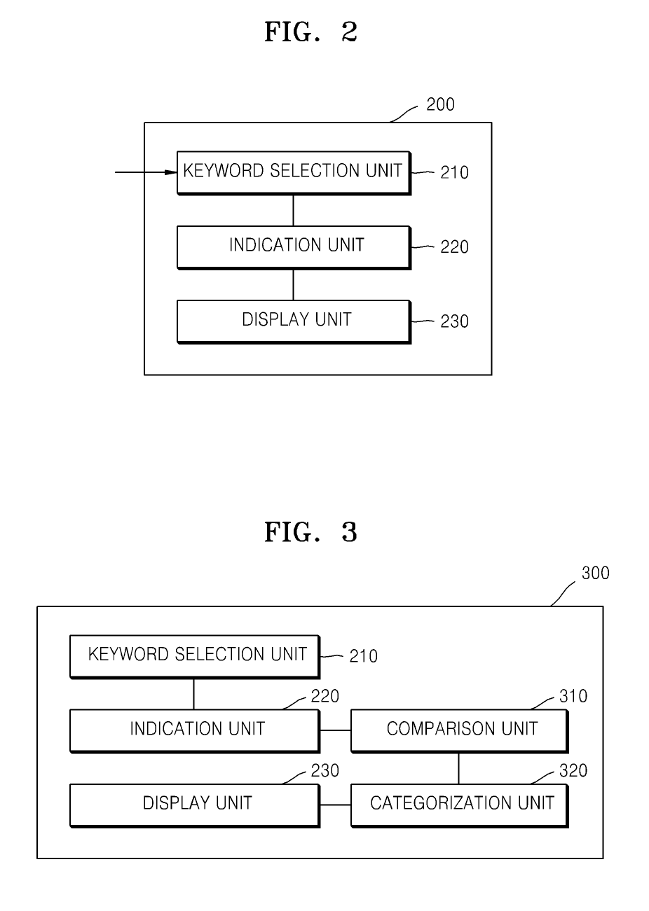

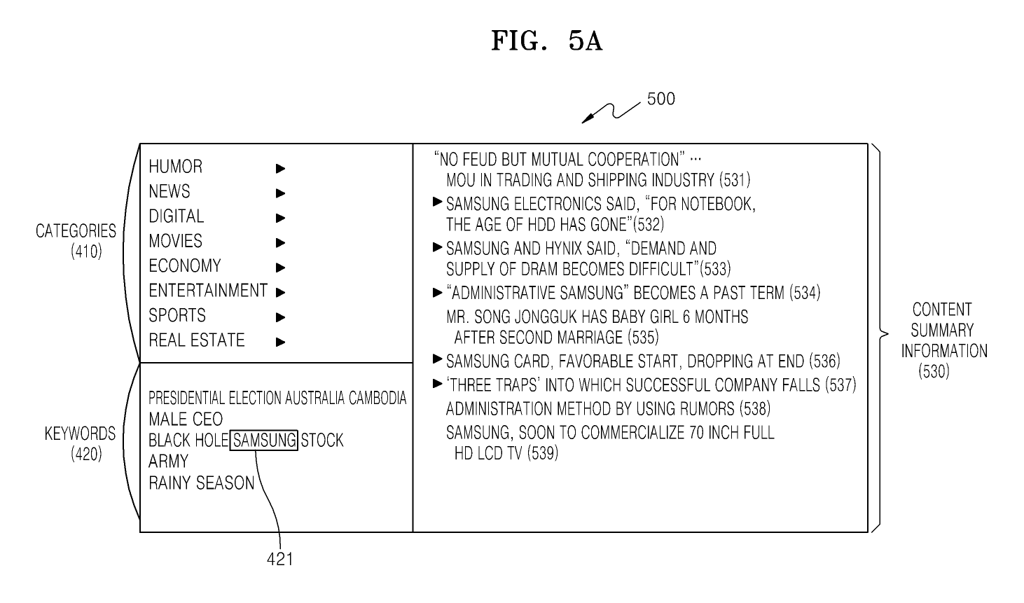

FIG. 2 is a block diagram of a content summary information providing apparatus 200 according to an embodiment of the present invention. The content summary information providing apparatus 200 includes a keyword selection unit 210, an indication unit 220, and a display unit 230. While not required, it is understood that the apparatus 200 can be included in a computer, a telephone, a personal digital assistant, a portable media player, or other portable or non-portable device capable of utilizing the content summary information. Operation of the apparatus 200 will be made with reference to a screen 400 shown in FIG. 4.

The keyword selection unit 210 automatically selects keywords 420 which satisfy a predetermined condition from among a plurality of keywords extracted from a plurality of pieces of content summary information. According to an aspect of the present invention, the pieces of content summary information 430 are pieces of content summary information provided from a content summary information provider which has been previously registered by a user. However, it is understood that the content summary information is not limited to such, and may be provided in other ways, for example, from content summary information providers which have not been registered by a user.

According to an aspect of the present invention, the content summary information 430 is data of a web syndication format, such as Rich Site Summary (RSS) or Atom, but is not limited thereto. The RSS format is a standard by which a user previously registers sites such as news sites or blogs, in which content is frequently updated, and is easily provided with updated contents. The RSS format is configured by using an Extensible Markup Language (XML) and includes a content title, content summary information, a content date, etc. In the case where the content summary information is transmitted as RSS data, the content summary information provider corresponds to an “RSS Feed” of the RSS 1.0 standard. However, other versions of the RSS can be used in addition to or instead of RSS 1.0. The Atom format performs functions which are substantially similar to the functions performed by the RSS and is configured by using the XML. The Atom format is a new standard developed so as to solve a problem regarding unification of the RSS format.

Methods of extracting the keywords from the plurality of pieces of content summary information may vary according to various aspects of the present information. For example, first, the content summary information is disassembled according to a proper size. In the case where the content summary information is based on the Korean language or the English language, the content summary information may be disassembled according to a word-spacing operation. Next, the keywords are extracted from the content summary information that has been disassembled according to the proper size. In the case of the Korean language, the keywords may be extracted by separating a morpheme. For example, in the case where the content summary information is “a purpose of floating Samsung Card,” this content summary information is first disassembled according to the word-spacing. Thus, the content summary information is disassembled as “a, purpose, of, floating, Samsung, Card.” Next, the keywords are extracted. By excluding the morphemes that are postpositions or a relative of the disassembled content summary information, it is possible to extract the keywords mainly comprised of nouns. Thus, for example, “Samsung,” “Card,” “float,” and “purpose” are extracted as the keywords. However, the extraction techniques are not limited to the above example.

When the extraction of the keywords is completed, the keywords which satisfy a predetermined condition from among the plurality of extracted keywords are selected. Predetermined conditions to select the keywords may vary according to various aspects of the present invention.

For example, according to an aspect of the present invention, the predetermined condition may be in regard to the number of keywords redundantly extracted. Thus, for example, the top 10 keywords which are frequently and redundantly extracted may be selected. Since there is a high possibility that such keywords, which are frequently and redundantly extracted, are included in contents concerning recently issued topics, it is quite probable that content summary information including such keywords may be content summary information desired by a user.

As another example, the predetermined condition may be in regard to user desired content information. Thus, keywords related to user desired content may be selected. The user desired content information may be previously input by the user, or may be obtained by analyzing an application executed in a user terminal. In this manner, by selecting the keywords according to the user desired content information, the user desired content is effectively displayed. Moreover, the predetermined condition may also be proximity of the extracted keywords or time of posting, and may also be combinations of top keywords, user selected keywords, or other conditions.

The indication unit 220 indicates the selected keywords 420 provided from the keyword selection unit 210. The indication unit 220 may indicate the selected keywords 420 in various ways, for example, by outputting the selected keywords 420 for display on in a sub-window of a screen 400 as shown in FIG. 4. When a user selects one of the displayed keywords 420, such as by highlighting the selected keyword 421, the indication unit 220 controls the display of those pieces of content summary information 430 having that keyword 421 so as to enable a user to reduce the amount of content summary information 430 to only those with the selected keyword 421 as opposed to all of the indicated keywords 420. Otherwise, the screen 400 displays all content summary information 430 having one or more of the displayed keywords 420.

When the user selects one of the keywords 420, the display unit 230 displays one or more pieces of content summary information 430 which is related to one or more selected keywords 421. That is, the user selects one or more desired keywords 421 from among the keywords 420 indicated by the indication unit 220 and displayed by the display unit 230 on the screen 400. When the user selects one or more keywords 421, content summary information 430 related to the keywords 421 from among the plurality of pieces of content summary information is displayed by the display unit 230. The display of the content summary information 430 can be in a second sub-window as shown in FIG. 4. It is understood that the display unit 230 can be integral to the apparatus 200 or connected to the apparatus 200 through wired and/or wireless connections. Moreover, other display arrangements can be used other than the shown sub-window arrangement, such as where the keywords 420 and/or the keyword 421 appear in a common window with the content summary information 430 or where the keywords 420 and/or the keyword 421 appear in a separate window from the content summary information 430 (such as through the use of pop-up windows).

According to an aspect of the present invention, the content summary information 430 is searched to determine which pieces of the content summary information 430 include the keywords 421 selected by the user. According to another aspect of the present invention, content corresponding to by the content summary information 430 is searched to determine which pieces of the content include the keywords 421 selected by the user. Moreover, the search can be of a combination of the content and the content summary information 430.

According to an aspect of the present invention, the user may select two or more selected keywords 421 from among the displayed keywords 420 using the indication unit 220. In this case, the display unit 230 may display content summary information 430 related to all of the selected keywords 421 (an AND condition), or may display content summary information 430 related to at least one of the selected keywords 421 (an OR condition).

The indication unit 220 which indicates the selected keywords 421 and the display unit 230 which displays the content summary information 430 may be embodied in separate devices or may be embodied in a single device. That is, by using a single display unit 230, keywords 420 and content summary information 430 may be rotationally displayed or may be displayed together.

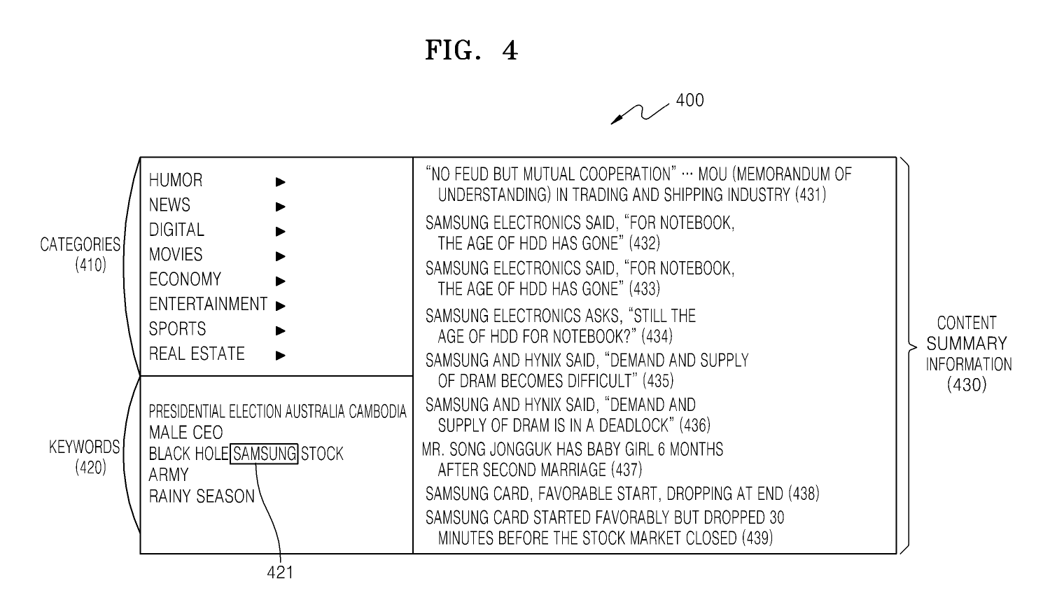

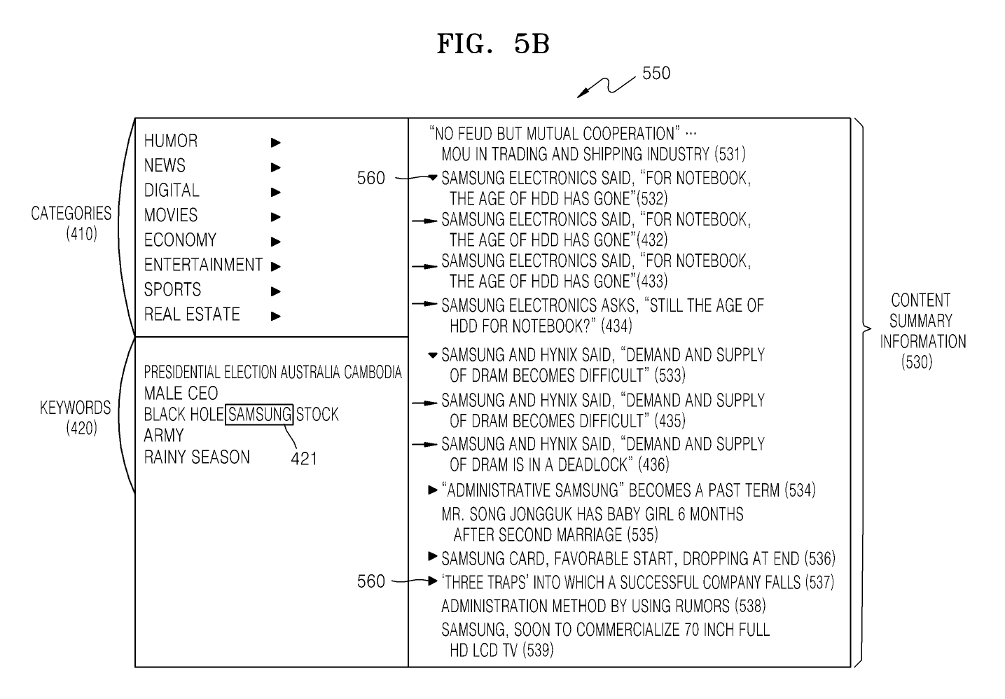

FIG. 3 is a block diagram of a content summary information providing apparatus 300 according to another embodiment of the present invention. The content summary information providing apparatus 300 includes the keyword selection unit 210, the indication unit 220, the display unit 230, a comparison unit 310, and a categorization unit 320. The keyword selection unit 210, the indication unit 220, and the display unit 230 included in the content summary information providing apparatus 300 are substantially similar to those described in relation to FIG. 2, and thus, a description thereof will be omitted. The operation of the comparison unit 310, and the categorization unit 320 will be explained with reference to the screens 500, 550 shown in FIGS. 5A and 5B.

The comparison unit 310 compares each piece of content summary information 530 related to one or more keywords 421 selected by a user and determines whether the respective pieces of content summary information 530 are mutually redundant. In this case, the comparison unit 310 compares respective keywords extracted from the respective pieces of content summary information 530 by the keyword selection unit 210, and thereby determines whether the respective pieces of content summary information 530 are redundant. As a result of the comparison performed by the comparison unit 310, the categorization unit 320 categorizes the redundant pieces of content summary information 530 into a same group if the categorization unit 320 determines that the respective pieces of content summary information are redundant. It is understood, however, that the categorization unit 320 is not limited to categorizing the redundant pieces of content summary information into one group, and may instead categorize the redundant pieces of content summary information into multiple groups according to various conditions.

As a result of the comparison performed by the comparison unit 310, the categorization unit 320 categorizes a plurality of pieces of content summary information 530, each of which has matched keywords exceeding a predetermined threshold value, into a same group. For example, the predetermined threshold value can be set to two matching keywords. In this case, it is assumed that each piece of content summary information 530, which has more than two redundant keywords extracted from the respective pieces of content summary information, is considered to be related to the same content and therefore is categorized into the same group. Other conditions can be used, such as keyword proximity, time of posting of the content, or similarity of keywords, and the number of keywords indicating redundancy can be other than two matching keywords.

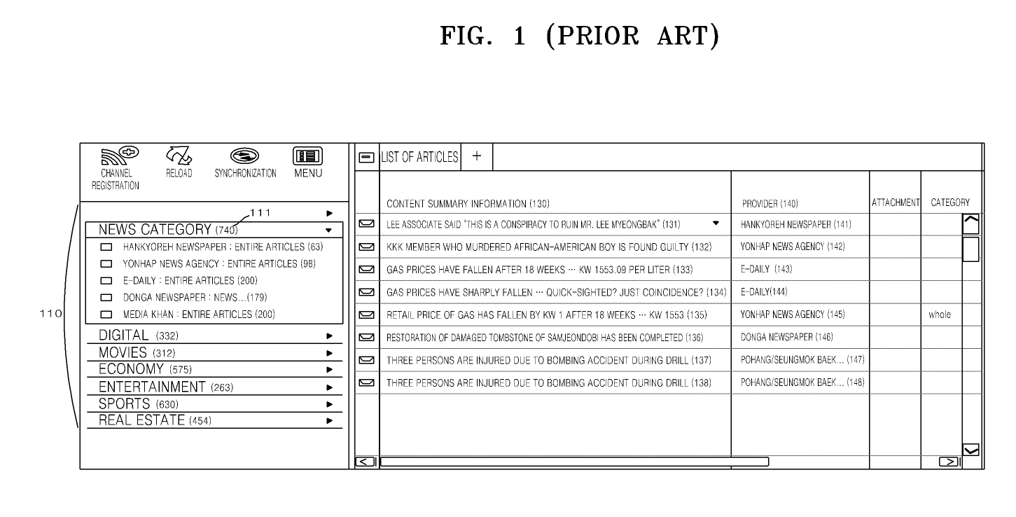

By way of example using the content summary information shown in FIG. 1, Keywords such as “gas, price, 18 weeks, fall, liter, KW 1553” may be extracted from the content summary information “gas prices have fallen after 18 weeks . . . KW 1553.09 per liter” 133 from among the plurality of pieces of the content summary information 130 displayed in the screen 100 of FIG. 1. Also, keywords such as “gas, retail price, 18 weeks, KW 1, KW 1553” may be extracted from the content summary information “retail price of gas has fallen by KW 1 after 18 weeks . . . KW 1553” 135. In this regard, three keywords of “gas,” “18 weeks,” and “KW” 1553” are matched with each other in the corresponding content summary information 133 and 135, which exceeds the predetermined threshold value of two matching keywords. Hence, the corresponding content summary information 133 and 135 are considered as redundant content summary information 130 and are therefore categorized into a same group. It is understood that the predetermined threshold value may be set to more or less than two keywords, and that the matching can include synonyms of the keyword (such as “gas” and “gasoline” and “KW” and “Korean Won”).

According to another aspect of the present invention, as a result of the comparison performed by the comparison unit 310, the categorization unit 320 categorizes a plurality of pieces of content summary information 130, in which a percentage of matched keywords is respectively over a threshold percentage value, into a same group. For example, the categorization unit 320 can be set to categorize two pieces of content summary information 130, in which the percentage of the matched keywords is over 50%, into the same group.

In this case, from among the plurality of pieces of the content summary information 130 displayed on the screen 100 of FIG. 1, each of the phrases of “gas prices have fallen after 18 weeks . . . KW 1553.09 per liter” 133 and “retail price of gas has fallen by KW 1 after 18 weeks . . . KW 1553” 135 is comprised of 6 keywords. Furthermore, the phrases in the content summary information 133 and 135 have three matched keywords, which are “gas,” “18 weeks,” and “KW 1553.” Therefore, a percentage of the matched keywords between the content summary information 133 and 135 is 50%. Thus, if the threshold value is set to a percentage of matched keywords equal to or exceeding a threshold value of 50%, the content summary information 133 and 135 are considered as redundant content summary information 130 and are thereby categorized into the same group. It is understood that the categorization unit 320 can determine whether the content summary information 130 is redundant by using the threshold value in various ways. For example, the categorization unit 320 can determine that the content summary information 130 is redundant if the matched keywords exceed the threshold value, equal or exceed the threshold value, etc.

Also, since the case in which keywords corresponding to numbers are matched with each other is more likely to be a case in which the content summary information 130 is redundant content summary information 130, compared to the case in which keywords corresponding to text are matched with each other, the comparison unit 310 determines the redundant content summary information by using various methods, such as the method of increasing a weight assigned to keywords corresponding to matching numbers. The categorization unit 320 categorizes the redundant content summary information 130 into a same group. Thus, for example, the keywords “KW 1553” and “18 weeks,” which include numbers, may be given more weight than the text terms such as “gas.”

According to an aspect of the present invention, the display unit 230 displays one piece of content summary information 530 from among the pieces of content summary information 530 which are categorized into the same group. The one piece of displayed content summary information 530 may be content summary information 530 that is primarily provided to a user terminal or may be content summary information 530 that is provided from a content summary information provider preferred by a user. In this case, the one piece of the displayed content summary information 530 may include address information or other identification information of another piece of content summary information 530 that is included in the same group. By doing so, in the case where the user desires to see another piece of content summary information 530 included in the same group, another piece of content summary information 530 that is redundant may be easily provided. By way of the example in screen 500, groups 532, 533, 534, 536, 537 contain redundant content summary information 530 which can be accessed by the user as shown in screen 550 and as will be described below.

FIG. 4 is a diagram illustrating an example of a screen 400 of the content summary information providing apparatus 200 shown in FIG. 2 which displays a plurality of pieces of content summary information 430. Categories 410, keywords 420, and pieces of content summary information 430 are displayed on the screen 400 of FIG. 4 using separate sub-windows. However, the display of the categories 410, keywords 420, and content summary information 530 is not limited to the shown example.

The categories 410 are used to categorize a plurality of pieces of content summary information 430. According to aspects of the present invention, the pieces of content summary information 430 are properly categorized into the categories 410 by a user or by a content summary information provider. The keywords 420 are keywords selected for display by the indication unit 220 from among a plurality of keywords extracted from the plurality of pieces of content summary information 430 by the keyword selection unit 210 since they satisfy a predetermined condition. Among the displayed keywords 420, an input (such as from a user) selects one of the displayed keywords 420 and is received by the indication unit 420. In the non-limiting example shown in FIG. 4, a keyword “Samsung” 421 from among the keywords 420 is selected by a user and is indicated through highlighting.

The pieces of content summary information 430 displayed on the screen 400 are related to the indicated keyword “Samsung” 421 which is selected from among the keywords 420 by the user. According to an aspect of the present invention, the pieces of content summary information 430 displayed on the screen 400 include “Samsung” 421, which is the indicated keyword 421 selected by the user. Otherwise, according to another aspect of the present invention, the contents corresponding to the pieces of content summary information 430 (but not necessarily the content summary information 430 itself) include the keyword “Samsung” 421. Furthermore, it is understood that both the content summary information 430 and the contents corresponding to the content summary information 430 may be searched for the keyword “Samsung” 421 selected by the user.

FIG. 5A is a diagram illustrating an example of a screen 500 of the content summary information providing apparatus 300 shown in FIG. 3 which displays pieces of content summary information 530, where the duplicate content summary information is further grouped. The categories 410 and the keywords 420 are generally like those displayed in the screen 400 of FIG. 4. The categories 410 are used to categorize a plurality of pieces of the content summary information 530. The keywords 420 are selected from among a plurality of the keywords 420 which are extracted from the plurality of pieces of content summary information 530 by the keyword selection unit 210 and satisfy a predetermined condition. In FIG. 5A, a keyword “Samsung” 421 from among the displayed keywords 420 is selected by a user and is thus indicated. The pieces of content summary information 530 related to the keyword “Samsung” 421 are the same as the pieces of content summary information 430 of FIG. 4, and thus, a description thereof will now be described with reference to FIG. 4. Additional elements related to grouping will be described with reference to FIGS. 5A and 5B for categorized content summary information.

While not required, it is understood the screen 400 can be a display prior to grouping and categorization by the comparison unit 310 and the categorization unit 320, and screens 500 and 550 are displayed after grouping and categorization. The comparison unit 310 compares each of the pieces of content summary information 430 related to the keyword “Samsung” 421 that is the keyword 420 selected by the user. At this time, a comparison is performed based on keywords extracted from each of the plurality of pieces of content summary information 430 (as opposed to the displayed keywords 420). As an example, it is assumed that the categorization unit 320 categorizes pieces of content summary information 530, which each have more than three matched extracted keywords with each other, into the same group as a result of the comparison performed by the comparison unit 310. However, it is understood that the categorization unit 320 may instead categorize the pieces of content summary information 530 according to other criteria, such as whether a percentage of the keywords match each other, etc.

By way of example, from within the content summary information 430 corresponding to the keyword 421, keywords such as “Samsung,” “electronics,” “notebook,” “hard disk drive (HDD),” and “age” are extracted from the phrases “Samsung electronics said, for notebook, the age of HDD has gone” 432, 433, which are pieces of content summary information 430 displayed on the screen 400 of FIG. 4. Also, keywords such as “Samsung,” “electronics,” “notebook,” “HDD,” and “age” are extracted from the phrase “Samsung electronics asks, still the age of HDD for notebook?” 434. Since more than three keywords are matched with each other from among the corresponding three pieces of content summary information 432, 433, and 434, the categorization unit 320 determines the corresponding three pieces of content summary information 432, 433, and 434 are redundant pieces of content summary information and thereby categorizes the corresponding three pieces of content summary information 432, 433, and 434 into a first group 532.

Also, keywords such as “Samsung,” “Hynix,” “Dynamic RAM (DRAM),” and “supplement” are extracted from the phrase “Samsung and Hynix said, demand and supply of DRAM becomes difficult” 435, and keywords such as “Samsung,” “Hynix,” “DRAM,” “demand and supply,” and “deadlock” are extracted from “Samsung and Hynix said, demand and supply of DRAM is in a deadlock” 436. Since more than three keywords are matched with each other from among the corresponding two pieces of content summary information 435 and 436, the categorization unit 320 determines the corresponding two pieces of content summary information 435 and 436 are redundant pieces of content summary information 420 and thereby categorizes the corresponding two pieces of content summary information 435 and 436 into a second group 533.

By using the same method, the categorization unit 320 categorizes the phrases “Samsung Card, favorable start, dropping end” 438 and “Samsung Card started favorably but dropped 30 minutes before the stock market closed” 439 into a third group 536. It is understood that the categorization unit 320 may also use other methods according to other aspects of the present invention, such as proximity of key words in a sentence or paragraph, and is not limited to categorizing pieces of content summary information 430 according to whether three keywords match.

According to an aspect of the present invention, the display unit 230 displays one piece of content summary information 530 from among a plurality of pieces of the content summary information 530 which are categorized into a same group. As shown in FIG. 5A, in the current example, only the phrase “Samsung electronics said, for notebook, the age of HDD has gone” 432 is displayed in the first group of 532, only “Samsung and Hynix said, demand and supply of DRAM becomes difficult” 435 is displayed in the second group 533, and only “Samsung Card, favorable start, dropping end” 438 is displayed in the third group 536. For the rest of the pieces of redundant content summary information 433, 434, 436, 439 that are included in the first, second, and third groups 532, 533, 536 but are not displayed, link information may be generated (shown as an arrow) so as to be immediately provided to users upon request.

FIG. 5B is a diagram illustrating a screen 550 of the content summary information providing apparatus 300 in which the pieces of content summary information 530 are displayed. Like reference numerals in the screen 550 of the content summary information providing apparatus 300 according to the present embodiment denote like elements which are previously described with reference to FIG. 5A, and thus a description thereof will be omitted here. A plurality of marks 560 is displayed, and each mark 560 corresponds to a piece of redundant content summary information 530, such as content summary information 532, 533, 536, and 537 may be displayed. When a user selects one of the marks 560 or one of the pieces of redundant content summary information 532, 533, 536, and 537, a plurality of pieces of redundant content summary information which were not displayed 433, 434, 436 are displayed by using generated link information. As shown, the mark 560 is a pull down arrow. However, the mark 560 may be other icons or non-icon indicia (such as color).

For example, when a user selects the content summary information 532 in FIG. 5A, the pieces of redundant content summary information 432, 433, and 434 are displayed as in FIG. 5B. Likewise, when the user selects the content summary information 533, redundant content summary information 435 and 436 are displayed.

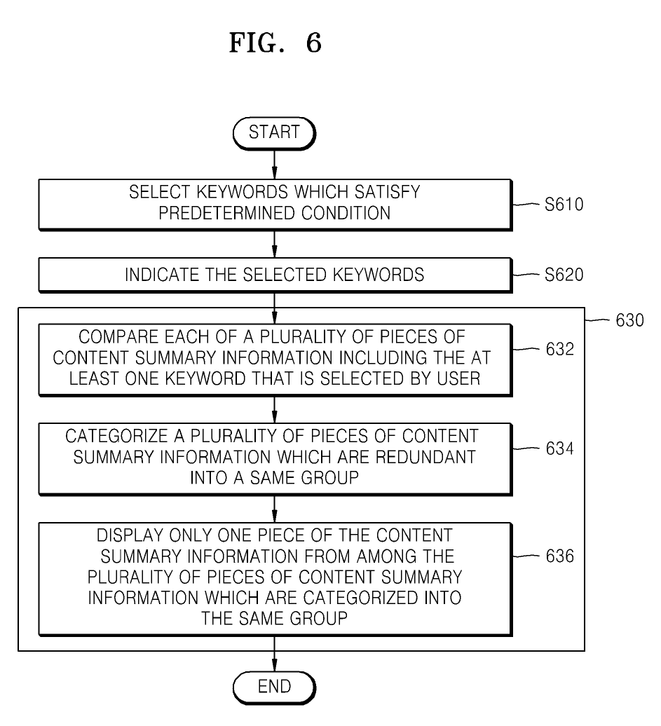

FIG. 6 is a flowchart of a method of providing content summary information 430, according to an embodiment of the present invention. In operation S610, keywords 420 are selected which satisfy a predetermined condition and which are from among a plurality of keywords extracted from a plurality of pieces of content summary information 430. According to an aspect of the present invention, the pieces of content summary information 430 are provided from registered content summary information providers, although it is understood that the second content summary information 430 may be provided from other sources as well.

In operation S610, the keywords 420 may satisfy a wide variety of predetermined conditions according to various aspects of the present invention. For example, keywords 420 may be selected which are redundantly extracted over a predetermined number of times, or which satisfy user desired content information that is previously set.

In operation S620, the selected keywords 420 are indicated. For example, the selected keywords 420 may be indicated by the indication unit 220 controlling the display of the keywords 420 as in FIG. 4.

In operation S630, pieces of content summary information 430 related to one or more keywords 421, which are selected by a user from among the selected keywords 420, are displayed. An example is shown in the display 400 of FIG. 4 and the user-selected keyword 421 is highlighted as compared to the remaining displayed keywords 420.

According to an aspect of the present invention, operation S630 is embodied by performing operations S632, S634, and S636. In operation S632, the pieces of content summary information 420 related to one or more selected keywords 421 are respectively and mutually compared. In operation S632, the pieces of content summary information 430 related to one or more selected keywords 421 respectively and mutually compared based on keywords extracted from each of the pieces of content summary information 430. The keywords extracted in operation S632 can be those already extracted in operation S610, and/or can be extracted again in operation S610.

In operation S634, as a result of the comparison performed in operation S632, pieces of the content summary information 530, which are redundant, are categorized into a same group. According to aspects of the present invention, as the result of the comparison performed in operation S632, pieces of the content summary information 530, which have matched keywords over a predetermined threshold value (such as, for example, three common keywords) may be categorized into a same group, or pieces of the content summary information 530 in which a percentage of the matched keywords is respectively over a threshold value (such as, for example, 25%, 50%, 60%, etc.) may be categorized into a same group. An example of such grouping is shown in FIG. 5A (where the redundant content summary information is not displayed), and in FIG. 5B (where the redundant content summary information is displayed due to the selection of the mark 560).

In operation S636, one piece of the plurality of pieces of the content summary information 430 which are categorized into the same group is displayed. It is understood, however, that more than one piece of the plurality of pieces of the content summary information 430 may instead be displayed according to other aspects of the present invention.

Aspects of the present invention provide a method and apparatus which display selected content and content summary information 430 related to a keyword 420 selected by a user, thereby efficiently providing user desired content.

Also, when the content summary information 430 is displayed, aspects of the present invention only display content summary information 530 that is not redundant, thereby efficiently providing the content desired by a user.

The embodiments of the present invention can be written as computer programs and can be implemented in general-use digital computers that execute the programs using a computer readable recording medium. In addition, a data structure used in the embodiments of the present invention can be written in a computer readable recording medium through various means. Examples of the computer readable recording medium include magnetic storage media (e.g., ROM, floppy disks, hard disks, etc.) and optical recording media (e.g., CD-ROMs, or DVDs). Further, aspects of the invention can be implemented by transmission through the internet, such as through carrier waves.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of providing content summary information, the method comprising:
selecting keywords which satisfy a predetermined condition from among a plurality of keywords extracted from a plurality of pieces of content summary information;
indicating the selected keywords to allow a user selection of at least one of the indicated keywords; and
in response to the user selection of at least one of the indicated keywords, displaying a plurality of pieces of content summary information all of which are related to the at least one user-selected keyword.

2. The method of claim 1, wherein the predetermined condition is a keyword having being redundantly extracted from the plurality of pieces of content summary information at least a predetermined number of times.

3. The method of claim 1, wherein the predetermined condition a user desired content information that is previously set before the selecting of the keywords.

4. The method of claim 1, wherein the displaying of the plurality of pieces of content summary information comprises:
comparing each of the pieces of content summary information related to the at least one user-selected keyword, based on keywords extracted from the plurality of pieces of content summary information related to the at least one user-selected keyword;
categorizing pieces of the content summary information comprising the at least one user-selected keyword and which include redundant extracted keywords into a same group, based on a result of the comparing; and
displaying only one piece of the content summary information from among the plurality of pieces of content summary information which are categorized into the same group.

5. The method of claim 4, wherein the categorizing comprises categorizing into the same group the plurality of pieces of content summary information having a number of matched extracted keywords over a predetermined number.

6. The method of claim 4, wherein the categorizing comprises categorizing into the same group the plurality of pieces of content summary information in which a percentage of matched keywords is respectively over a threshold percentage value.

7. The method of claim 1, wherein the plurality of pieces of content summary information is provided from a registered content summary information provider.

8. The method of claim 1, wherein the content summary information is Rich Site Summary (RSS) data.

9. A content summary information providing apparatus, comprising:
a keyword selection unit to select keywords which satisfy a predetermined condition from among a plurality of keywords extracted from a plurality of pieces of content summary information;
an indication unit to indicate the selected keywords so as to allow a user selection of at least one of the indicated keywords; and
a display unit to display, in response to the user selection of at least one of the indicated keywords, a plurality of pieces of content summary information, each of which is related to the at least one user-selected keyword.

10. The content summary information providing apparatus of claim 9, wherein the predetermined condition is a keyword having being redundantly extracted from the plurality of pieces of content summary information at least a predetermined number of times.

11. The content summary information providing apparatus of claim 9, wherein the predetermined condition is user desired content information that is previously set before the selection unit selects the keywords.

12. The content summary information providing apparatus of claim 9, further comprising:
a comparison unit to compare the pieces of content summary information related to the at least one user-selected keyword, based on keywords extracted from the plurality of pieces of content summary information related to the at least one user-selected keyword; and
a categorization unit to categorize the pieces of content summary information comprising the at least one user-selected keyword and which have are redundant extracted keywords into a same group, based on a result of the comparison,
wherein the display unit displays only one piece of the content summary information from among the plurality of pieces of content summary information which are categorized into the same group.

13. The content summary information providing apparatus of claim 12, wherein the categorization unit categorizes into the same group the plurality of pieces of content summary information having a number of matched keywords over a predetermined number.

14. The content summary information providing apparatus of claim 12, wherein the categorization unit categorizes into a same group the plurality of pieces of content summary information in which a percentage of matched keywords is respectively over a threshold percentage.

15. The content summary information providing apparatus of claim 9, wherein the plurality of pieces of content summary information is provided from a registered content summary information provider.

16. The content summary information providing apparatus of claim 9, wherein the content summary information comprises Rich Site Summary (RSS) data.

17. A computer readable recording medium having recorded thereon a program for executing the method of claim 1.

18. A method of providing content summary information using a web content syndication format, the method comprising:
determining whether multiple pieces of content summary information are substantially redundant with each other based on common keywords contained in the content and/or content summary information of the pieces; and
displaying one of the pieces of content summary information to represent multiple pieces of the content summary information determined to be substantially redundant according to the determination.

19. The method of claim 18, wherein the determining comprises:
automatically selecting the keywords from a plurality of received content summary information pieces based on a predetermined condition; and
comparing the multiple pieces of content summary information which are related to one of the automatically selected keywords based on a received user selection.

20. The method of claim 18, wherein the displaying of one of the pieces of content summary information comprises displaying the one piece and generating link information for the remaining substantially redundant pieces of the content summary information to be provided to a user upon request.

21. The method of claim 18, wherein the displaying of one of the pieces of content summary information comprises displaying the one piece and further displaying a mark next to the one piece so that when a user selects the mark, the remaining substantially redundant pieces which were not displayed are displayed by using generated link information.

22. The method of claim 18, wherein the content summary information comprises Rich Site Summary (RSS) data.

23. The method of claim 19, further comprising:
displaying the keywords determined to be automatically selected in a first sub-window; and
receiving a user selection of one of the displayed keywords in the first sub-window, wherein the displaying of the pieces comprises displaying the pieces in a second sub-window.

24. A content summary information providing apparatus to be used with a web content syndication format, comprising:
a comparison unit to compare common keywords of multiple pieces of content summary information to determine whether the multiple pieces of content summary information are substantially redundant with each other; and
a display unit to display one of the pieces of content summary information to represent multiple pieces of the content summary information determined by the comparison unit to be substantially redundant.

25. The content summary information providing apparatus of claim 24, further comprising:
a categorization unit to categorize the multiple redundant pieces of content summary information into a same group based on a result of the comparison unit.

26. The content summary information providing apparatus of claim 24, further comprising:
a keyword selection unit to automatically select the keywords from a plurality of received pieces of content summary information based on a predetermined condition; and
an indication unit to indicate at least one of the automatically selected keywords based on a user selection so as to allow a selection of one of the automatically selected keywords,
wherein the comparison unit compares the keywords of multiple pieces of content summary information which are related to the indicated keyword.

27. The content summary information providing apparatus of claim 24, wherein the display unit displays the one piece of content summary information and generates link information for the remaining redundant pieces of the content summary information to be provided to a user upon request.

28. The content summary information providing apparatus of claim 24, wherein the display unit displays the one piece of content summary information and further displays a mark next to the one piece so that when a user selects the mark, the remaining redundant pieces which were not displayed are displayed by using generated link information.

29. The content summary information providing apparatus of claim 24, wherein the content summary information comprises Rich Site Summary (RSS) data.

30. The content summary information providing apparatus of claim 26, wherein the display unit displays:
a first sub-window to display the keywords which are automatically selected by the keyword selection unit, and to receive a user selection of one of the displayed keywords; and
a second sub-window to display the pieces of content summary information.
